(19) United States
(12) Patent Application Publication
(10) Pub. No.: US 2007/0040368 A1
(43) Pub. Date: Feb. 22, 2007

(54) One-piece woven airbag with tethers

(75) Inventor: Scott Manley, Gray Court, SC (US)

Correspondence Address: DORITY & MANNING, P.A., POST OFFICE BOX 1449, GREENVILLE, SC, 29602-1449, US

(73) Assignee: Safety Components Fabric Technologies, Inc.

(21) Appl. No.: 11/504,214

(22) Filed: Aug. 15, 2006

Related U.S. Application Data
(60) Provisional application No. 60/708,204, filed on Aug. 15, 2005.

(51) Int. Cl. B60R 21/23; B60R 21/213

(52) U.S. Cl. 280/743.2; 280/730.2

(57) ABSTRACT

Air bags for vehicles and processes for making the air bags are disclosed. In accordance with the present disclosure, the air bags include tethers that extend from one side of the air bag to the other side of the air bag and control the inflation characteristics of the bag. The tethers are integral with the air bag such that they are integrated into a woven pattern used to form the bag. The tethers can comprise yarn tethers or fabric tethers. In one embodiment, for instance, a one-piece air bag is disclosed that is formed from warp yarns and fill yarns that are not only used to construct the woven air bag but are also used to construct tethers incorporated into the bag.

### RELATED APPLICATIONS

The present application is based upon and claims priority to U.S. Provisional Patent Application having Ser. No. 60/708,204, filed on Aug. 15, 2005.

### BACKGROUND OF THE DISCLOSURE

Within a passenger compartment of a vehicle, many occupant restraint systems can be utilized, such as seatbelts and air bag systems. For instance, air bag systems can supplement the protection offered by seatbelts. Air bag systems typically comprise at least one folded air bag and an inflation gas. The air bag system is designed to inflate the air bag with the inflation gas when a collision between the vehicle and another object is detected.

Traditional air bag systems include driver side air bags, passenger side airbags, and side-impact air bags. Driver side air bags are normally located in the steering column of the vehicle and passenger side air bags are typically located in the dash board. Side-impact air bags include side cushion air bags, typically mounted in the outboard side of the seat, and side curtain air bags, which are usually stored in the roof line and connected along the door frame.

Driver side and passenger side air bags often include vent holes to expel the inflation gas relatively quickly after inflation. Side-impact air bags, in contrast, remain inflated over long periods of time in order to offer prolonged protection in events such as roll-over crashes.

Usually, air bags are made of a woven fabric due to the substantial force the air bag must sustain from the inflating gas during deployment. Many different materials, either coated or uncoated, have been utilized in the manufacture of air bags, for example as described in U.S. Pat. Nos. 5,881,776 and 6,632,753, both of which are incorporated by reference herein.

Air bags in the past have been made using various techniques and processes. For example, in some applications, air bags are made by sewing together various panels. In other applications, instead of being made from separate panels, the air bags are made in a single weaving operation using, for instance, a Jacquard loom. Jacquard looms, for example, are capable of weaving together an air bag including a first side separated from a second side joined by a woven seam in one single operation. Such air bags are known in the art as “one-piece woven” air bags.

Air bags often require the inclusion of some feature that is present to shape the air bag into a desired dimension upon inflation. For instance, air bags often include tethers to limit the volume the air bag encompasses upon deployment. Tethers are utilized to prevent the air bag from “ballooning” in undesired areas. The tethers may be located internally or externally. Normally, the tethers are sewn into the air bag, either between the air bag layers or on the surface, after the air bag has been sewn.

Typically, air bags incorporating tethers are constructed by a cut and sew method. For example, in order to incorporate tethers into air bags, tethers are typically sewn into the bag manually. Thus, the incorporation of tethers into air bags tends to be not only labor intensive, but also requires a significant amount of time.

Lobes are often utilized to shape the air bags also. In lobed air bags, a seam is sewn or woven at various locations along the air bag sealing the first side to the second side in order to restrict the volume of the air bag upon deployment. Although incorporating lobes into air bags may be useful in some applications, the lobes have a tendency to form a non-uniform product when inflated. Thus, some lobed air bags do not create a uniform surface for contact with a passenger during vehicle accidents thus possibly reducing the amount of protection provided to the passenger.

In addition, the seams that are woven into the air bags to form the lobes can create stress points in the product during inflation. These concentrated stress areas may cause unwanted gas leakage along the seams. Thus, in some embodiments, it is desirable to reduce or eliminate the number of seams contained within the product.

In view of the above, a need currently exists for an improved air bag in which tethers are constructed integral with the bag. Specifically, a need exists for an air bag containing tethers and for a process for producing the air bag in which the tethers are woven into the product as the bag itself is being woven. In this manner, the air bag may be formed containing tethers without any separate processing steps, such as a separate cut and sew process.

### SUMMARY

In general, the present disclosure is directed to an air bag that has tethers that have been integrally formed with the air bag. The tethers can be, for instance, yarn tethers or fabric tethers. The air bag can be made from a one-piece woven fabric in which the tethers are integrated into the weave pattern used to form the bag.

In one embodiment, for instance, the present disclosure is directed to an air bag including a first side spaced from a second side defining a gas inflatable volume therebetween. The first side and the second side, for instance, may comprise woven materials. In accordance with the present disclosure, at least one tether extends from the first side of the air bag to the second side. The tether is integral with the first and second sides.

For example, in one embodiment, the tether can be attached to the first side of the air bag by at least one tack point and can also be attached to the second side of the air bag by at least one tack point. The tether may comprise a yarn tether. For instance, in one embodiment, the air bag can be made from warp yarns and fill yarns and can include a plurality of tethers that are constructed from the fill yarns only, from the warp yarns only, or from a combination of fill yarns and warp yarns. When present, the yarn tethers can be uniformly distributed across the interior of the air bag. Alternatively, however, the yarn tethers may be non-uniformly distributed across the bag and may be concentrated in certain areas.

In addition to yarn tethers, air bags can be made according to the present disclosure including woven fabric tethers. In this embodiment, for instance, the air bag can have a one-piece construction and can be made from warp yarns and fill yarns. The warp yarns and fill yarns that are used to form the air bag can also be used to form woven fabric tethers within the bag. In one particular embodiment, the air bag comprises a Jacquard woven bag.

Air bags made according to the present disclosure may be uncoated or coated. In one embodiment, for instance, a coating may be applied to the exterior surface of the air bag in order to reduce the permeability of the first and second sides. In general, for instance, the air bag can have a permeability of less than about 4 cfm, such as from about 0.5 cfm to about 3 cfm.

The air bag can be made from any suitable materials. For instance, in one embodiment, the air bag can be made from spun yarns, monofilament yarns, multifilament yarns, or combinations thereof. In one particular embodiment, for example, the air bag can be constructed from nylon multifilament yarns having a denier of from about 210 to about 630.

The tethers that are integrated into the air bag can have any suitable length. For instance, the tethers can have a length of from about one-half inch to about 20 inches, such as from about 2 inches to about 12 inches. The number of tethers present within the air bag can also vary depending upon the particular application. In general, sufficient tethers should be incorporated into the bag so that the tethers can withstand the force of an inflation gas.

Further aspects and features of the present disclosure are discussed in greater detail below.

### BRIEF DESCRIPTION OF THE DRAWINGS

A full and enabling disclosure of the present invention, including the best mode thereof to one of ordinary skill in the art, is set forth more particularly in the remainder of this specification, including reference to the accompanying figures in which:

FIG. 1 depicts a perspective view of an inflated side-curtain air bag;

FIG. 2 depicts a perspective view of one embodiment of the present disclosure with yarn tethers integrated into a one-piece air bag, woven between a first side and a second side.

FIG. 3A depicts a cross-sectional view of one embodiment of the present disclosure illustrating yarn tethers integrated into a one-piece air bag, woven in the fill direction between a first side and a second side.

FIG. 3B depicts a cut-away top view of one embodiment of the present disclosure illustrating yarn tethers integrated into a one-piece air bag, woven in the fill direction between a first side and a second side.

FIG. 4A depicts a cross-sectional view of one embodiment of the present disclosure illustrating tethers integrated into a one-piece air bag, woven in the warp direction between a first side and a second side.

FIG. 4B depicts a cut-away top view of one embodiment of the present disclosure illustrating yarn tethers integrated into a one-piece air bag, woven in the warp direction between a first side and a second side.

FIG. 5A depicts a cross-sectional view of one embodiment of the present disclosure illustrating yarn tethers integrated into a one-piece air bag, woven in both the warp and fill directions between a first side and a second side.

FIG. 5B depicts a cut-away top view of one embodiment of the present disclosure illustrating yarn tethers integrated into a one-piece air bag, woven in both the warp and fill directions.

FIG. 6 depicts a perspective view of one embodiment of the present disclosure illustrating fabric tethers integrated into a one-piece air bag woven in either the warp or fill direction.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations.

In general, the present disclosure is directed to a one-piece woven air bag in which tethers are woven directly into the air bag between a first side and a second side by a weaving device. For example, in the one embodiment, the air bag is woven on a weaving device in which yarn or fabric tethers are woven between the two layers of the air bag. In this manner, the tethers become integral with the air bag as the air bag is being formed. In one embodiment, the air bag containing the tethers is formed by a Jacquard loom weaving device. It should be understood, however, that any suitable weaving device may be used that is capable of weaving a one-piece woven air bag with internally integrated tethers.

The term “one-piece woven” hereinafter refers to an air bag that is constructed on a weaving apparatus in essentially one process step. For example, one-piece air bags may be formed on a weaving device that is capable of continuously and simultaneously forming air bags having a first side joined with a second side by a seam. In accordance with the present disclosure, the one-piece air bags may further include tethers that are integrated into the air bag structure during the weaving process. One-piece air bags may be coated with a chemical composition or uncoated in order to control the permeability or other physical properties of the bag.

The term “tethers” hereinafter refers to any fiber, yarn, or fabric attached to both the first side and the second side of the air bag, which serves the purpose for shaping the air bag to the desired dimensions upon inflation. Furthermore, the term “yarn tethers” further describes “tethers” that are formed from unwoven yarns. The term “fabric tethers” also further describes “tethers” indicating that the tethers are formed from a woven material.

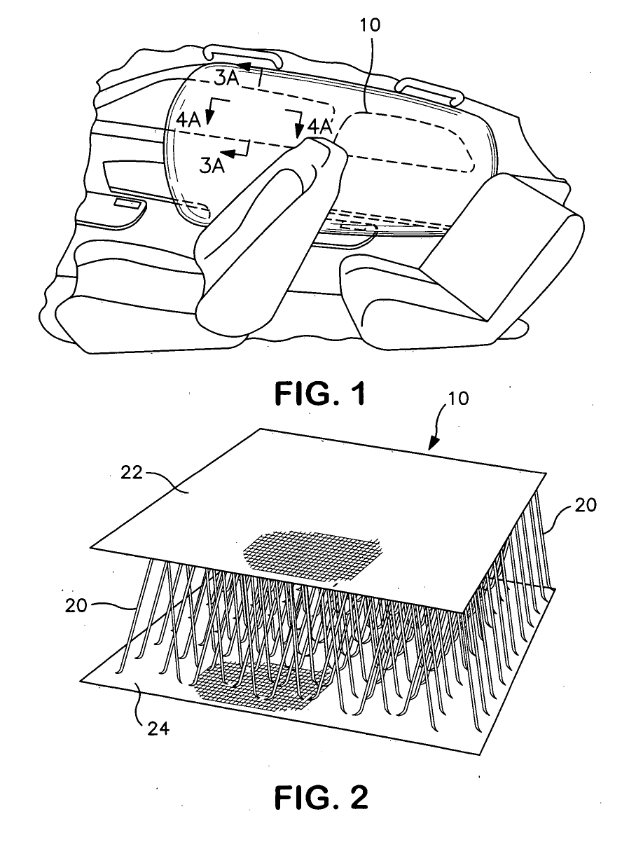

Referring to FIG. 1, one embodiment of a deployed side-curtain air bag 10 is illustrated that may be constructed according to the present disclosure. Directional arrows 3A and 4A are shown to illustrate the direction in which the tethers are woven into the air bag as will be described in more detail below. In FIG. 1, 3A depicts the fill direction and 4A depicts the warp direction.

Air bags constructed in accordance with the present disclosure that contain tethers integral with the construction of the bag offer many advantages and benefits. One advantage is that production can be completed in fewer steps without having to incorporate the tether into the bags in a separate operation. Furthermore, since the tethers are integrated into the weave pattern, the process can be completely automated.

In addition, one-piece woven air bags containing tethers that have been woven into the bag may be produced without containing any sewn seams. Sewn seams cannot only produce more of a weakened stress point in the bag but may also adversely affect the gas holding properties of the bag.

In one embodiment, air bags can be constructed containing tethers without having to also utilize lobes to direct the air bag's shape thus perhaps creating a flatter surface during impact. It should be understood, however, that lobes may also be present in the air bag in combination with the tethers.

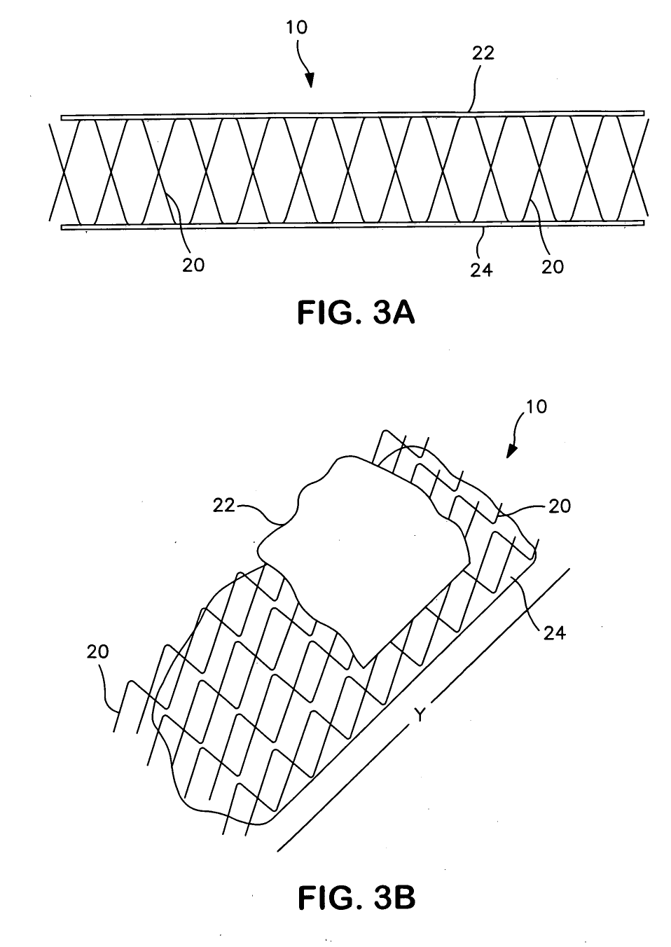

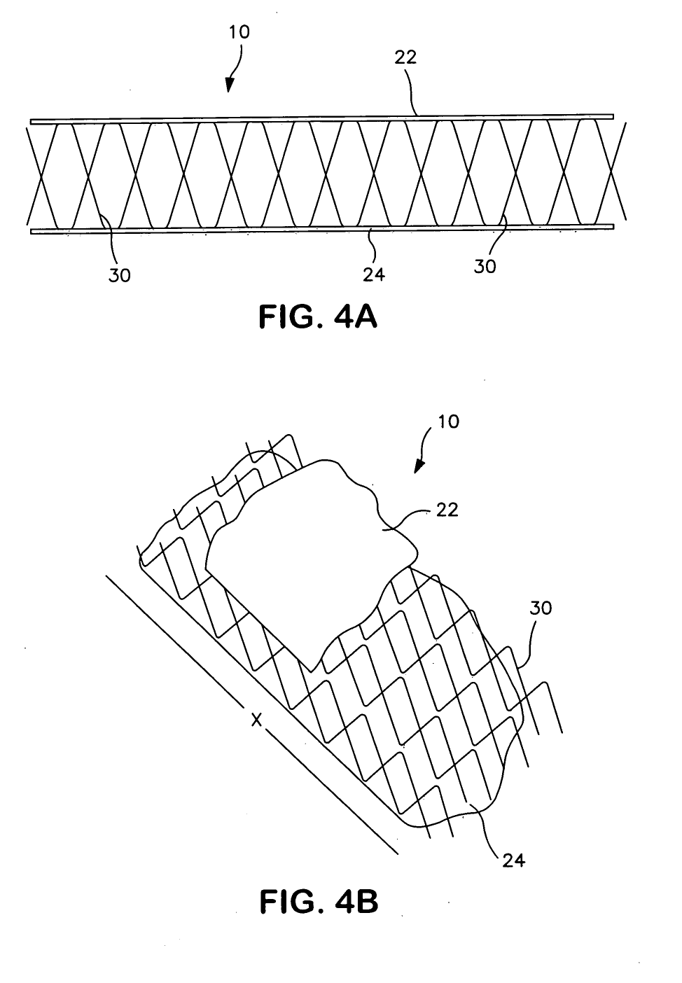

Referring to FIGS. 2, 3A and 3B, one embodiment of an air bag 10 containing yarn tethers 20 is illustrated. As shown, in this embodiment, the tethers 20 comprise unwoven yarn that extends in between a first side 22 and a second side 24 of the air bag 10. In the embodiment illustrated in FIGS. 2, 3A and 3B, the yarn tethers are woven into the air bag 10 in the fill direction Y between the first side 22 and the second side 24.

The first side 22 and second side 24 are joined by a seam along the perimeter of the air bag (not shown). In accordance with the present disclosure, the tethers 20 are formed in between the first side 22 and the second side 24 of the air bag 10 while the air bag itself is being woven. For example, in one embodiment, the air bag 10 may comprise a one-piece air bag containing the tethers 20.

The tethers 20 may be formed in the air bag 10 using any suitable method or process. In one particular embodiment, for instance, the tethers 20 may be woven into the air bag 10 using a suitable weaving device, such as a Jacquard loom. A Jacquard loom utilizes a highly versatile pattern mechanism to permit the production of large, intricate weaves. A Jacquard loom is capable of controlling the action of individual warp yarns or relatively small groups of warp yarns during the passage of each pick or fill. In this manner, very complex weave patterns can be produced. In fact, weave patterns can be made that when removed from the loom have a 3-dimensional configuration in the X, Y, and Z-planes. In accordance with the present disclosure, with proper manipulation and designing of a weave pattern, a Jacquard loom can be utilized to weave a one-piece air bag with tethers integrated into the bag and extending in between the two sides of the bag.

For example, the Jacquard loom can be placed in association with a controller. The controller, which may comprise a microprocessor such as a computer, may be preprogrammed with an appropriate Jacquard pattern for forming air bags in accordance with the present disclosure. Specifically, various software is commercially available that may be used in conjunction with a Jacquard weaving device.

The Jacquard weaving device, in one embodiment, may include a plurality of cords which are in control of the warp yarns. In one embodiment, for example, each individual warp yarn or group of warp yarns may be connected to a separate and corresponding cord. The cords are adapted to lift selected warp yarns at predetermined times during the weaving operation. When selected warp yarns are lifted, a “shed” is formed through which the fill yarns are inserted. By controlling each individual warp yarn or group of warp yarns during the weaving process, intricate 3-dimensional woven patterns can be formed, such as one-piece air bags containing integrated tethers.

In the embodiments illustrated in FIGS. 2, 3A and 3B, the yarn tethers 20 comprise fill yarns that are woven into the air bag 10 in the cross-machine direction, opposite the direction of the warp yarns. As shown, the yarn tethers 20 extend from the first side 22 to the second side 24. More particularly, each yarn tether 20 is woven into the first side 22 of the air bag 10 for a predetermined distance to form a tack point and then extends to the second side 24 of the air bag 10. The yarn tether is then woven into the second side 24 of the air bag 10 for a predetermined distance to form another tack point and is then once again directed to the first side 22. In this embodiment, this process is repeated causing the tether yarn 20 to extend in between the two sides of the air bag in a zig-zag pattern.

During production of the air bag 10 as shown in FIG. 2, various fill yarns are selected to serve as the yarn tethers 20. For example, in one embodiment, from about every second fill yarn to about every fiftieth fill yarn or greater may be utilized as a yarn tether. For example, in one particular embodiment, approximately from every third yarn to every tenth yarn may be utilized as a yarn tether. In one particular embodiment, for example, approximately every fifth fill yarn may be utilized as a yarn tether.

The yarn tethers 20 as shown in FIG. 2 may have any desired length. As used herein, the length of a tether refers to the distance the tether separates a first side of the air bag from a second side. The length of a tether may depend on various different factors, including the type of air bag being constructed and the amount of inflation that is desired. For instance, the tethers may have a length such that the air bag when inflated provides sufficient protection to an occupant. The tethers, however, may be limited in size so as not to require a relatively large amount of gas generation to properly pressurize the air bag for an unnecessarily larger volume. In general, the length of the yarn tethers may be from about one-half inch to about twenty inches in length. For instance, in one embodiment, the tethers may have a length of from about two inches to about eight inches between tack points.

The number of yarn tethers may also vary dramatically depending upon the particular application and the desired results. In general, enough yarn tethers may be incorporated into the air bag so as to withstand the force of the inflation gas.

FIG. 3B illustrates one embodiment in which the tethers are distributed relatively uniformly in the fill direction Y throughout the air bag. However, since a Jacquard loom has the ability to control each warp yarn or group of warp yarns, the tethers are not necessarily woven into the bag uniformly. Tethers may be placed at any position of the air bag in order to shape the air bag into any inflated dimension desired. Further, the tethers may be uniformly distributed across the thickness of the air bag as shown in FIGS. 2, 3A and 3B or may be present in the air bag in a non-uniform manner. For example, in one embodiment, a collection of yarn tethers may be concentrated at certain areas of the air bag surrounded by areas where no tethers exist.

The materials used to construct the air bag 10 as shown in FIGS. 2, 3A and 3B may also vary depending upon the particular application. For instance, the air bag 10 may be woven from any suitable material such as natural fibers including cotton, wool, linen, ramie, hemp, and the like or synthetic fibers including polyester, polyamides, rayon, polyolefin, acrylic, and the like. As used herein, the term “yarn” may refer to a single filament yarn, a multi-filament yarn, a spun yarn, and the like.

In one embodiment, the yarns of which the air bag is constructed may comprise multifilament nylon yarn. The multi-filament nylon yarns may have any suitable denier, such as a denier up to about 630. Adjusting the denier of the yarn affects various properties of the air bag. For example, smaller yarn sizes can produce an air bag that may be easier to pack in an air bag compartment of a vehicle. For instance, smaller yarn sizes may produce a fabric with better packability properties. In addition to packability properties, the denier of the yarns may also impact the permeability of the material. For example, smaller yarn sizes generally tend to decrease the air permeability of the woven fabric.

In one embodiment, the multi-filament nylon yarns have a size of less than about 630 denier such as from about 630 denier to about 210 denier or less. For example, in various embodiments, the nylon yarn may have a size of approximately 315 denier with approximately 140 filaments, resulting in a denier per filament (DPF) linear density of approximately 2.25. Alternatively, a higher DPF linear density air bag may be constructed of nylon yarns that have a size of approximately 315 denier with approximately 70 filaments (6 DPF).

The desired permeability of the first and second sides of the air bag may vary. For instance, a side-curtain air bag is required to remain inflated for longer than a driver-side or passenger-side air bag. This is to allow greater protection in side-impact crashes and during vehicle rollovers.

One test for permeability is referred to as the “leak down” test. During a leak down test, the air bag is inflated to a particular pressure. After a period of time, the pressure in the air bag is then recorded to determine the pressure drop during the time interval. For example, in one embodiment, a side curtain air bag may be inflated to a pressure of 13 psi. Seven seconds after being inflated to the above pressure, the remaining pressure in the bag may be determined. For side impact air bags, for instance, after seven seconds, the air bag should retain at least about 60% of the original pressure, such as at least about 80% of the original pressure. If desired, the air bag may be coated with a chemical composition, such as a polymer, in order to control the permeability of the bag.

In one embodiment, the weave construction of the first side 22 and second side 24 comprises about a 60×60 plain weave for 315 denier nylon construction or about 48×48 plain weave for 420 denier nylon construction. It should be understood, however, that the above described weave construction is merely exemplary and that various weave patterns, weave densities, yarn sizes, and yarn materials may be used to construct air bags in accordance with the present disclosure.

Referring to FIGS. 4A and 4B, another embodiment of an air bag 10 made in accordance with the present disclosure is illustrated. In this embodiment, the air bag 10 includes a first side 22 spaced from a second side 24 by a plurality of yarn tethers 30. The yarn tethers 30 instead of comprising fill yarns in this embodiment comprise warp yarns. The warp yarn tethers 30 are woven into the air bag in the warp direction X.

FIG. 4B illustrates one embodiment in which the tethers are distributed relatively uniformly throughout the air bag. Again, since a Jacquard loom has the ability to control each warp yarn or group of warp yarns, the tethers are not necessarily woven into the bag uniformly. Tethers could be placed at any position of the air bag in order to shape the air bag into any inflated dimension desired.

When forming the air bag 10 as shown in FIGS. 4A and 4B, the warp yarns may be fed into the weaving process from a beam. When the warp yarns are used to form yarn tethers, differences in tension across the warp beam may be experienced since the warp yarns used to form the tethers require less amounts of yarn than when the yarns are used to form the woven first side 22 and second side 24. Thus, when the warp yarns are used to form tethers, various processing techniques may be needed in order to ensure that the warp yarns are consumed by the weaving process at a similar rate over the repeat of the weave.

In an alternative embodiment, each of the warp yarns may be used to form a yarn tether at different times in order to maintain constant tension. Alternating the yarns to form the yarn tethers ensures that equal amounts of warp yarn are used across the warp beam. Of course, in some embodiments, yarn tension may not be an issue during the weaving process.

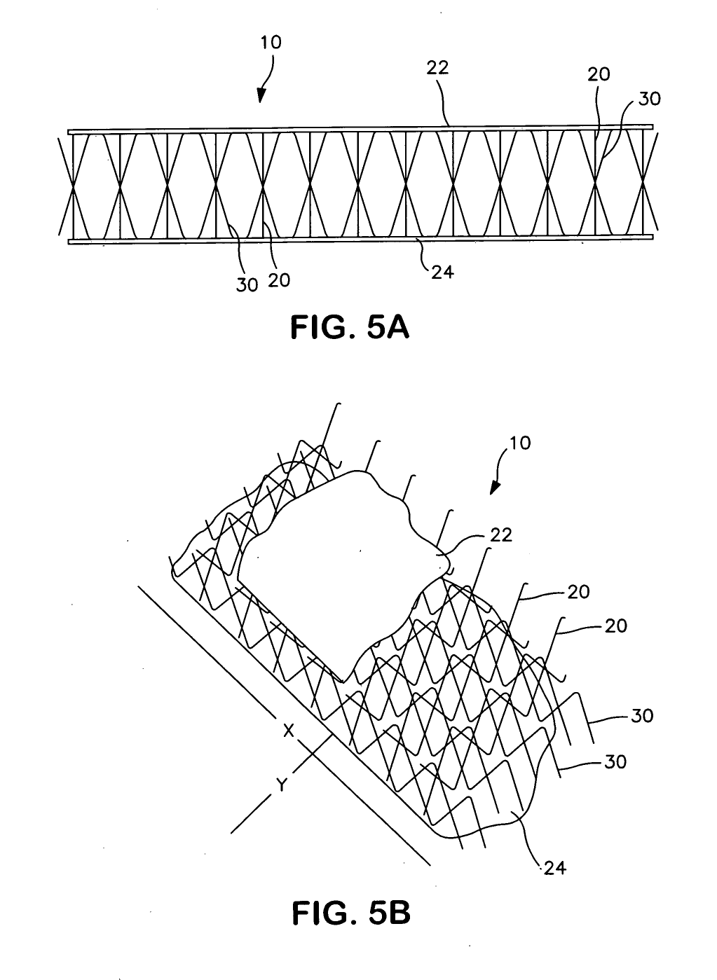

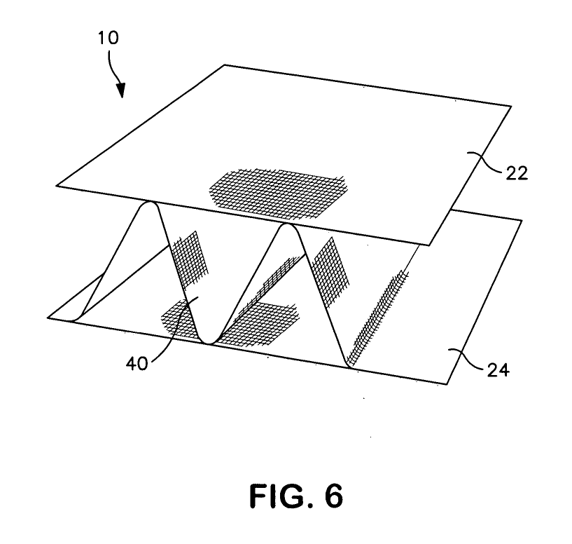

Referring to FIGS. 5A and 5B, still another embodiment of an air bag 10 made in accordance with the present disclosure is shown. Specifically, FIGS. 5A-5B illustrate a cross-sectional and cut-away view of an air bag 10 according to the present invention in which yarn tethers 20 and 30 are woven into the air bag in both the fill and warp directions X and Y. FIG. 5B illustrates one embodiment in which the tethers are distributed relatively uniformly throughout the air bag. Again, since a Jacquard loom has the ability to control each warp yarn or group of warp yarns, the tethers are not necessarily woven into the bag uniformly. Tethers could be placed at any position of the air bag in order to shape the air bag into any inflated dimension desired or to provide additional strength in any needed areas.

In addition to yarn tethers, air bags may be made according to the present invention containing fabric tethers. In this embodiment, the tethers comprise a woven fabric made from, for instance, a combination of warp and fill yarns. The fabric tethers may comprise a tightly woven fabric or may comprise a mesh material. For example, FIG. 6 illustrates one embodiment of the present disclosure in which fabric tethers 40 are integrated into the air bag 10, woven between a first side 22 and a second side 24 of the air bag. The fabric tethers 40 may be woven in either the warp direction or the fill direction.

While the fabric tethers 40 are typically constructed of the same material as sides 22 and 24, they are not necessarily woven in the same weave pattern. For instance, the weave may be a relatively loose weave in comparison to the weave of the air bag layers.

While FIG. 6 illustrates the fabric tethers 40 woven in a relatively uniform pattern, the fabric tethers 40 may be placed at any position in the air bag in order to shape the air bag to a desired inflated dimension. In fact, fabric tethers may be able to withstand higher tensile forces than yarn tethers due to a higher density of material. As such, fewer fabric tethers may be required to withstand the overall tensile stress impacted on the tethers during the rapid inflation that occurs when the air bag is deployed.

In another embodiment of the present invention, both yarn and fabric tethers 20 or 30 and 40 are woven directly into the air bag. Either the yarn or the fabric tethers may be woven into the air bag in either the warp or fill directions. For example, a combination of yarn tethers and fabric tethers may be used in order to provide an optimum combination of strength and air permeability.

Upon construction of a one-piece woven air bag with woven tethers internally integrated, the air bag may be coated with any suitable coating if needed by any suitable method. Typical coating methods include spraying, printing such as rotogravure printing, dip-coating, slot-coating, extrusion, and the like. In general, any suitable chemical compound, such as a polymer, may be applied to the air bag to control air permeability. Typical coating compounds include silicon, urethane, neoprene, and the like. In one embodiment, the air bag is dip-coated with silicon after weaving.

These and other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention.

What is claimed is:

1. An air bag comprising:
a first side spaced from a second side defining a gas inflatable volume therebetween, the first side and the second side comprising woven materials; and
at least one tether extending from the first side to the second side, the tether being integral with the first and second sides.

2. An air bag as defined in claim 1, wherein the air bag comprises a one-piece air bag.

3. An air bag as defined in claim 1, wherein the tether is attached to the first side of the air bag by at least one tack point and is also attached to the second side of the air bag by at least one tack point.

4. An air bag as defined in claim 3, wherein at least one tether comprises a warp yarn tether.

5. An air bag as defined in claim 3, wherein at least one tether comprises a fill yarn tether.

6. An air bag as defined in claim 3, wherein the air bag includes a plurality of yarn tethers, a first portion of the yarn tethers comprising warp yarns and a second portion of the yarn tethers comprising fill yarns.

7. An air bag as defined in claim 3, wherein at least one tether comprises a woven fabric tether.

8. An air bag as defined in claim 7, wherein the woven fabric tether is formed from warp yarns and fill yarns used to form the first side and second side of the bag.

9. An air bag as defined in claim 1, wherein the air bag comprises a Jacquard woven bag.

10. An air bag as defined in claim 1, wherein the first side comprises a woven fabric made according to a first weave pattern and wherein the second side comprises a woven fabric made according to a second weave pattern, and wherein at least one tether is integrated into the first weave pattern and the second weave pattern.

11. An air bag as defined in claim 1, wherein the air bag defines an exterior surface, the exterior surface including a coating that reduces the permeability of the first and second sides.

12. An air bag as defined in claim 1, wherein the air bag comprises a side-curtain air bag.

13. An air bag as defined in claim 1, wherein the at least one tether has a length of from about one-half inch to about 20 inches.

14. An air bag as defined in claim 1, wherein the air bag is made from multifilament yarns, the yarns having a denier of from about 210 to about 630.

15. An air bag comprising:
a one-piece woven fabric comprising a first side spaced from a second side and defining a cavity therebetween for receiving an inflation gas; and
at least one tether extending from the first side to the second side, the tether being integral with the one-piece woven fabric such that the tether is integrated into a woven pattern that forms the fabric.

16. An air bag as defined in claim 15, wherein the at least one tether comprises a plurality of yarn tethers.

17. An air bag as defined in claim 16, wherein the woven fabric includes fill yarns and warp yarns and wherein the plurality of tethers are only made from the fill yarns.

18. An air bag as defined in claim 16, wherein the woven fabric includes fill yarns and warp yarns and wherein the plurality of tethers are only made from the warp yarns.

19. An air bag as defined in claim 16, wherein the woven fabric includes fill yarns and warp yarns and wherein the plurality of yarn tethers comprise both warp yarns and fill yarns.

20. An air bag as defined in claim 17, wherein from about every third fill yarn to about every tenth fill yarn contained in the woven fabric comprises one of the yarn tethers.

21. An air bag as defined in claim 16, wherein the tethers are attached to the first side of the air bag by at least one tack point and are also attached to the second side of the air bag by at least one tack point.

22. An air bag as defined in claim 15, wherein at least one tether has a length of from about 2 inches to about 12 inches.

23. An air bag as defined in claim 15, wherein the air bag is made from multifilament yarns, the yarns having a denier of from about 210 to about 630.

24. An air bag as defined in claim 16, wherein the plurality of tethers are non-uniformly distributed between the first side and the second side of the air bag, the tethers being concentrated in certain areas.

25. An air bag as defined in claim 15, wherein at least one tether comprises a woven fabric tether.

26. An air bag as defined in claim 25, wherein the woven fabric is comprised of fill yarns and warp yarns and wherein the woven fabric tether is constructed from the fill yarns and warp yarns.

27. An air bag as defined in claim 15, wherein the air bag does not include any sewn seams.

28. An air bag as defined in claim 15, wherein the air bag does include a sewn seam.

29. A side-curtain air bag comprising:
A one-piece woven fabric structure having a shape configured to drape along the side of a vehicle, the woven fabric structure including a first side spaced from a second side and defining a cavity therebetween for receiving an inflation gas; and
At least one tether extending from the first side to the second side, the tether being integral with the woven fabric structure such that the tether is integrated into a woven pattern that forms the fabric structure.

30. A side-curtain air bag as defined in claim 29, wherein the air bag is constructed such that after the air bag is inflated to a pressure of 13 psi, the bag decreases in pressure by no more than about 40% after seven seconds.

31. A side-curtain air bag as defined in claim 29, wherein the air bag is constructed such that after the air bag is inflated to a pressure of 13 psi, the bag decreases in pressure by no more than about 20% after seven seconds.

32. A side-curtain air bag as defined in claim 29, wherein the at least one tether comprises a plurality of yarn tethers.

33. A side-curtain air bag as defined in claim 29, wherein the at least one tether has a length of from about 2 inches to about 12 inches.

34. A side-curtain air bag as defined in claim 29, wherein the air bag is made from multifilament yarns, the yarns having a denier of from about 210 to about 630.

35. A side-curtain air bag as defined in claim 32, wherein the plurality of tethers are non-uniformly distributed between the first side and the second side of the air bag, the tethers being concentrated in certain areas.

36. A side-curtain air bag as defined in claim 29, wherein at least one tether comprises a woven fabric tether.

37. A side-curtain air bag as defined in claim 36, wherein the woven fabric structure is comprised of fill yarns and warp yarns and wherein the woven fabric tether is constructed from the fill yarns and warp yarns.
